(19) United States
(12) Patent Application Publication
(10) Pub. No.: US 2005/0255999 A1
(43) Pub. Date: Nov. 17, 2005

(54) Faux metallic imaging thermally responsive record material

(75) Inventor: Mark Robert Fisher, Appleton, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 10/842,732

(22) Filed: May 11, 2004

(51) Int. Cl. B41M 5/40

(52) U.S. Cl. 503/226

(57) ABSTRACT

Thermally imaging systems are disclosed incorporating a layer of an optical color shifting material coated over a heat sensitive layer to provide direct thermally imaging recording materials that express lustrous metallic effects when heated with a thermal printhead. The color shifting material such as interference pigments are coated as a layer applied over a heat sensitive layer. The optical color shifting materials cooperate in a unique fashion with the underlying chromogen, preferably darkly imaging, of the heat sensitive layer to yield a faux metallic toned image that appears to be an additive effect of the underlying chromogen and the chromatic tone of the color shifting material. A new class of metallic imaging thermally-responsive recording material is taught.

### FIELD OF THE INVENTION

This invention relates to thermally-responsive record material. It more particularly relates to such record material in the form of sheets coated with color-forming systems comprising chromogenic material (electron-donating dye precursors) and acidic (electron accepting) color developer material. This invention particularly concerns a thermally-responsive record material capable of forming a substantially non-reversible image. The present invention teaches a unique color-shifted thermally responsive record material that enables formation of thermal images which are uniquely metallic in appearance or luster, or colored to express a different coloration than that normally expressed by the chromogen.

### DESCRIPTION OF THE RELATED ART

Thermally-responsive record material systems are well known in the art and are described in many patents, for example, U.S. Pat. Nos. 3,539,375; 3,674,535; 3,746,675; 4,151,748; 4,181,771; 4,246,318; 4,470,057 which are incorporated herein by reference. In these systems, basic chromogenic material and acidic color developer material are contained in a coating on a substrate which, when heated to a suitable temperature, melt or soften to permit said materials to react, thereby producing a colored mark.

Thermally-responsive record materials, particularly commonly encountered commercial variants, typically express a neutral or black coloration when thermally imaged. Multicolor thermally imaging substrates are known premised on incorporating different chromogenic dye precursors, such as different leuco or flouran dye precursors in solid resin particles, or in microcapsules (U.S. Pat. No. 6,680,281) or in different transparent layers. Others have proposed heat sensitive systems based on leuco or flouran dyes of differing colors laminated into multiple heat sensitive layers, each layer exhibiting different color hues (U.S. Pat. No. 6,667,275). Use of plural kinds of electron donating dye precursors or chromogens today is the conventional technique to introduce different hues into the same heat sensitive recording material. (U.S. patent appl. 20030224935, Dec. 4, 2003, Fuji Photo). U.S. patent application 20030138720, Jul. 24, 2003, to Fuji Photo teaches a heat sensitive thermally imaging recording material wherein one heat sensitive layer develops a cyan color, another one yellow, and yet another layer magenta.

Interference pigments are also known, however their use has been primarily in automotive finishes, cosmetics, and some printed documents. They have not been coupled in the art with thermally imaging direct thermal recording materials.

U.S. Pat. No. 5,573,584 discloses a process for preparing forgery proof documents by printing with interference pigments. The pigments are formed by overcoating platelet-like silicatic substrates (micas, talc or glass flakes) with a first colorless or selectively absorbing metal oxide layer of high refractive index, and a second non-selectively absorbing metal oxide in combination with scattering pigments. The second non-selectively absorbing semitransparent layer may be composed of carbon, a metal, or a metal oxide, which, for example, can be applied by gas phase decomposition of volatile compounds, such as compounds of iron, cobalt, nickel, chromium, molybdenum or tungsten, or metal oxides such as iron oxide, magnetite, nickel oxide, cobalt oxides, vanadium oxides, or mixtures thereof.

U.S. Pat. No. 5,116,664 discloses a pigment that is made by coating a first layer of Ti₀₂ onto mica followed by coating on the TiO₂ layer with powder particles of at least one of the metals cobalt, nickel, copper, zinc, tin, gold, and silver.

High chroma interference platelets are disclosed in U.S. Pat. No. 5,571,624. These platelets are formed from a symmetrical multilayer thin film structure in which a first semi-opaque layer such as chromium is formed on a substrate, with a first dielectric layer formed on the first semi-opaque layer. An opaque reflecting metal layer such as aluminum is formed on the first dielectric layer, followed by a second dielectric layer of the same material and thickness as the first dielectric layer. A second semi-opaque layer of the same material and thickness as the first semi-opaque layer is formed on the second dielectric layer. For the color shifting designs, the dielectric materials utilized, such as magnesium fluoride, have an index of refraction less than 2.0.

Thin film flakes having a preselected color are taught in U.S. Pat. No. 4,434,010. The flakes are formed by depositing a semi-opaque metal layer upon a flexible material, followed by a dielectric layer, a metal reflecting layer, another dielectric layer, and finally another semi-opaque metal layer. The thin film layers are specifically ordered in a symmetric fashion such that the same intended color is achieved regardless of whether the flakes have one or the other lateral face directed towards the incident radiation.

It is an object of the present invention to teach a novel direct thermal recording material that expresses a metallic image when thermally imaged.

It is a further object of the present invention in one embodiment to disclose a thermally imaging record material that can express two colors based on a single chromogen.

It is a yet further object of the invention to disclose a thermally imaging record material that can express multiple colors or a second color different from one chromogen or set of chromogens expressing a first color of the heat sensitive layer.

### SUMMARY OF THE INVENTION

Disclosed is a thermally-responsive record material comprising a substrate having provided thereon a heat sensitive color-forming composition comprising a chromogenic material and an electron accepting developer material. Overcoated over the heat sensitive color-forming composition is at least one layer of an optical color shifting material in a polymeric binder, that is preferably transparent or translucent.

In one embodiment of the thermally-responsive record material, the optical color shifting material layer can be coated only over a portion of the heat sensitive color-forming composition provided on the substrate. Alternatively, the heat sensitive color-forming composition is coated only over a portion of the substrate surface. Variations of such full or partial covering of the substrate with one or both coatings will be readily evident to the skilled artisan, as well as the use of optional intervening layers such as protectant layers, binders, antioxidant layers, UV absorbing layers and the like.

The advantage of partial coverage, such as coating the color shifting material over only a portion of the heat sensitive color forming composition is that the chromogenic material when thermally imaged expresses a first color in areas of the record material not coated with the optical color shifting material and the same chromogenic material expresses a second metallic non-neutral color when imaged in areas coated with the color shifting material.

Preferably the optical color shifting material is an interference pigment such as a metal oxide coated mica, a light polarizer, or a liquid crystal.

Preferably the optical color shifting materials are metal oxide coated mica having an optical thickness of 2,000 angstoms or less, such as titanium or zirconium oxide, and have a refractive index of less than 2. A high refraction pigment is desirable. In one embodiment the optical color shifting material has a refractive index of less than 2. In yet another embodiment, it is desirable if the high refraction pigment has a particle size of less than one half micrometer.

A UV layer can provide between the layer of the high refraction pigment and the heat sensitive layer, or as an overcoat layer. A protective topcoat of a polymeric material can also be advantageously employed.

In a preferred embodiment, the chromogenic material is selected to express a black or neutral color. Neutral means that the chromogenic material in contact with an acidic material typically expresses a black hue coloration.

In yet another embodiment, a method of forming faux metallic images on a thermally responsive substrate is disclosed. The method comprises providing a paper or film substrate having a first and second surface; applying to a first surface of the substrate a coating of a thermally-responsive color-forming composition in one or more layers. The thermally responsive color forming composition comprises a colorless or pale colored chromogenic material and an acidic developer material.

An optical color shifting material is dispersed into a polymeric binder, and applied over the coating of the thermally responsive color-forming composition in at least one layer.

The thermally responsive color forming composition is thermally imaged by selective application of heat through the layers of optical color shifting material such as with use of a thermal printhead, such that the chromogenic material reacts with the acidic developer material to form a visible color. The chromogenic material Visible color is a first color which is optically color shifted by the optical color shifting material to express a second color different from the first color of the chromogenic material. By first color is meant the normal color that the chromogenic material displays when reacted with an acidic material. The second color is the color shifted form of this color when the same color is viewed through the color shifting layer. As will be evident to the skilled artisan, the “first color” is best observed by viewing the expressed color of the heat sensitive layer in areas not coated with the color shifting material.

In another embodiment of the method, the coating of thermally responsive color forming composition is applied to only a portion of first surface of the substrate and the optical color shifting material is applied over the entire first surface of the substrate.

In yet another embodiment the coating of thermally responsive color forming composition is applied to the entire first surface of the substrate and the optical color shifting material is applied over only a portion of the first surface of the substrate wherein the chromogenic material when thermally imaged expresses a first color in areas of the record material not coated with the optical color shifting material and expresses a second non-neutral metallic color when imaged in areas coated with the color shifting material.

Variations would include coating of thermally responsive color forming composition such that it is applied to only a portion of the first surface of the substrate and the optical color shifting material is applied over only a portion of the first surface of the substrate.

### DETAILED DESCRIPTION

The present invention teaches a novel faux metallic imaging thermally-responsive record material. Heretofore, heat sensitive record materials such as facsimile papers, thermal labels, boarding passes, baggage tags and the like typically express a black image. Although chromogens expressing different colors such as red or green are known, the images produced are typically matte finish of the respective color.

The present invention teaches a thermally sensitive record material that images in metallic looking colors. Such thermal imaging record materials have been unknown prior to the invention.

The present invention is a thermally responsive record material comprising a support having provided thereon a heat sensitive color forming composition comprising:
a. a chromogenic material and an electron accepting color developer; and
b. at least one layer of an optical color shifting material coated over the heat sensitive color-forming composition.

Preferably the color shifting layer is applied directly over the heat sensitive color-forming composition. The heat sensitive color forming composition, as will be evident to the skilled artisan, can be formed of one or more layers of chromogen, developer, and optional modifiers and sensitizers. The heat sensitive composition is understood to encompass such variations of a heat sensitive layer or layers.

Although the color shifting layer is preferred applied over the color forming composition layer or layers, it is possible to include optional intervening layers of different functionality between the heat sensitive color forming composition and the applied layer of the overcoating optical color shifting material. Such intervening layers are preferably transparent or translucent and could include optional other additives such as UV inhibitors, antioxidants, absorbents, binders such as starch or acrylic resin emulsions, pigments, and the like. A protective or top coat can also be applied or coated over the optical color shifting layer.

The intervening layers are preferably transparent or translucent but can also be slightly colored.

The color shifting effect is particularly pronounced when a conventional lactone, leuco or flouran dye expressing a dark color such as a black or neutral hue is coupled with a color shifting layer. The thermal record material, for example can start as a blank white or lightly colored sheet, though white is preferred for paper. Surprisingly, a thermally imaging recording material is obtained that can express a faux metallic coloration such as a blue metallic even though the chromogenic material is expressing a black hue. This shift in coloration of the neutral color (black) starting from a colorless or white sheet to be perceived as a metallic blue and the like was surprising and unexpected.

For example, when the chromogenic material is selected to be 3-diethylamino-6-methyl-7-anilino-fluoran or 2-anilino-3-methyl-6-dibutylamino-fluoran, conventional thermally sensitive recording materials would exhibit a hue tending toward neutral or black. Prior to imaging, the sheet appears white. By coupling the neutral colored thermal image with an optical color shifting layer, such as titanium oxide coated mica in a polyvinyl alcohol or acrylate latex binder, surprisingly a metallic blue thermally-formed image results.

The invention teaches a thermally imaging recording material that shifts color from black or dark hues to metallic colored lustrous thermal images. Formation of metallic colors with direct thermal record materials has not been known in the art.

The invention is a unique direct thermal record material that images in faux metallic colors.

The optical color shifting materials are plate-like particles coated with a thin film of titanium dioxide or zirconium dioxide, preferably having an index of refraction higher than that of the plate-like particles. The plate-like particles are preferably transparent, translucent, or reflectant such as mica.

The thickness of the titanium dioxide or zirconium dioxide on the plate-like particles such as mica, produce different reflection colors. Set against the underlying black or dark image of the imaged thermally imaging layer, the expressed coloration provides a lustrous metallic effect. Unimaged areas of the substrate appear generally white with a slight sheen.

In an alternative embodiment, by spot printing or applying the color shifting material to only a portion of the thermally responsive record material, a two color thermally imaging record material is achieved based from potentially a single chromogen or dye precursor or single expressed color of the chromogen or chromogens residing in the heat-sensitive layer. Obviously the single chromogen can be a blend of chromogens such as flourans that together express a single color such as black or blue or other color. The reference to single chromogen is for purposes of illustration, not limitation.

Areas uncoated with the color shifting material for example image in black with a chromogen such as 2-anilino-3-methyl-6-dibutylamino flouran positioned in the heat sensitive layer. Other conventional flourans or other chromogens can be readily substituted or used in addition. In the areas of the substrate where the heat sensitive layer is overcoated with a layer of the color shifting material and binder, the observed hue is not black, but a color such as a metallic blue when metal oxide mica (Merck, Iriodin 221) coated mica is used as the color shifting material. Iriodin 221 is a trademark of Merck KGaA, Darmstadt, Germany.

Blue has previously been a difficult color or hue to express with a direct thermal record material. Blue hues in thermal systems have been poor in image stability. With the invention, this problem is overcome in that the chromogen can be black or neutral. Example 2A and 2B herein illustrate a metallic blue imaging thermally responsive record material. Additionally, the invention yields not only a stable blue, but a stable thermally imaged blue metallic.

The expressed blue metallic color, since based on a more stable actually neutral or black chromogen, yields a more stable blue direct thermal imaging record material.

The color shifting material can be a chromatic diffractive pigment such that the pigment particles produce a background color against the black background of the heat sensitive record material image. The effect is additive producing an intense color hue of the chromatic diffractive color shifting material.

Achromatic materials would add a metallic or pearlescent effect against the black background of the imaged areas of the heat sensitive record material image. Chromatic materials are preferred for their color shifting effect.

The preferred color shifting materials are platelet or flake-like particles such as mica. The preferred flakes do not exceed about 50 to 100 microns in the major direction. The thickness is in the order of about 50 nanometers to about 3000 nanometers or 3 microns. The aspect ratio of the flake width to thickness is preferably from about 10:1 to about 25:1.

The mica flakes are coated with a metal oxide, preferably titanium dioxide or zirconium dioxide.

The expressed color of the color shifting material can be fairly well correlated with the thickness of the metal oxide coating. The predominating color is reported to shift from silver to yellowish to golden to red to blue to green as the metal oxide coating layer on the mica increases in thickness.

Methods for producing metal oxide coated mica materials are described in U.S. Pat. Nos. 3,087,828 and 3,553,001 incorporated herein by reference.

Preferably the binder material in which the color shifting materials are dispersed is selected to have a lower refractive index than the refractive index of the color shifting material. Suitable binder materials include water soluble and water insoluble polymers including vinyl acetate emulsions, polyvinyl alcohol, carboxylated polyvinylalcohol, carboxylated polyvinylalcohol, polyarylamide, acrylic latex, starch, gelatin, styrene maleic anhydride, ethylene maleic anhydride copolymers and the like.

Other suitable color shifting materials include metal oxide coated platelet material such as metal oxide coated muscovite, biotite, phlogopite, glass flakes, phyllosilicates, silicon dioxide, vermiculite, sericite and synthetic and natural micas. Metal oxide coatings can include, by way of illustration and not limitation; titanium dioxide, zirconium oxide or iron oxide. Optionally other metal oxides can be combined for other inherent colors or tinctorial effects. Other useful materials can include platelike crystals of B-phthalocyanine, fluororubine, red perylenes, or diketopyrrolpyrroles. The micas or liquid crystals described herein later are preferred.

Other interference or color shifting pigments are taught in U.S. Pat. Nos. 4,434,010 and 3,438,796. Variations include glass or mica particles coated with metal layers and alternating Si0₂ and Ti0₂ layers.

The thickness of the metal oxide layer or layers in generally from 10 to about 1000 nm. TiO₂ and Fe0₃ layers on mica, for example, are taught in U.S. Pat. 6,692,561 to intensify tinting strength of the color shifting material.

The metal oxide is preferably of high refractive index and can be an oxide or mixture of oxides such as Ti0₂, 2r0₂, Fe₂0₃, Fe₃0₄, Zr₂0₃, or Zr0, or iron oxide hydrates, titanium suboxides and mixtures or mixed phases of these compounds with one another.

Multiple coatings of Ti0₂, Si0₂ and Ti0₂ for example are taught in U.S. Pat. No. 6,689,205 to produce an intense interference pigment that can function as a color shifting material herein by expressing an interference color observed against an underlying dark or black hue thermal imaged of the image heat sensitive layer of the record material of the invention.

Color shifting materials based on asymmetrical coatings applied to one side of a reflector layer are taught in U.S. Pat. No. 6,686,042. The coating structure includes a selective absorbing layer on one or more sides of a reflector layer, a dielectric layer on the selective absorbing layer, and an absorber layer on the dielectric layer.

Color shifting materials can include thin film flakes having a preselected color as taught in U.S. Pat. No. 4,434,010. The flakes are formed by depositing a semi-opaque metal layer upon a flexible material, followed by a dielectric layer, a metal reflecting layer, another dielectric layer, and finally another semi-opaque metal layer. The thin film layers are specifically ordered in a symmetric fashion such that the same intended color is achieved regardless of whether the flakes have one or the other lateral face directed towards the incident radiation.

High chroma interference platelets functional as color shifting materials are disclosed in U.S. Pat. No. 5,571,624. These platelets are formed from symmetrical multilayer thin film structures in which a first semi-opaque layer such as chromium is formed on a substrate, with a first dielectric layer formed on the first semi-opaque layer. An opaque reflecting metal layer such as aluminum is formed on the first dielectric layer, followed by a second dielectric layer of the same material and thickness as the first dielectric layer. A second semi-opaque layer of the same material and thickness as the first semi-opaque layer is formed on the second dielectric layer.

Interference pigments have been used previously in automotive finishes.

Interference pigments include bismuth oxychloride and titanium oxide coated mica. Plate-like iron oxides and plate-like phthalocyamines are also know. Interference pigments based on three layers of two materials are also known. Typically they have a thickness on the order of 500 nanometers. A low refractive index material such as mica is coated with a highly refractive metal oxide applied in a thin layer of about 50 to 150 nanometers. Interference pigments split light into two complimentary colors. The interference color dominates under conditions of maximum reflection which is typically the face angle. The transmitted part dominates at other viewing angles when there is a white nonabsorbing or reflecting background. Variations between face and incident rays produce a sharp gloss peak and a color change between two complimentary colors.

Interference pigments functional in the invention include liquid crystal materials which are anisitropic. These liquid crystals are formed into generally flat transparent platelets. The series of platelets are stacked. Each layer has a slightly different molecular orientation. The distance between two layers with similar molecular orientation define the coloration. The individual layers can include a chiral additive to tune the color by imparting an aspect of light polarization. The individual layers of the platelets are in essence twisted one relative the other.

Interference pigments of the liquid crystal types are available commercially as Helicone® pigments from Wacker Silicones, Adrian, Mich. (Wacker. Chemie GmbH).

Against a black background, the reflected interference color is seen as the mass tone of the material. This effect has been advantageously utilized in automotive paints, but until this invention has not been adopted to produce mass tone colors or hues in thermally imaging recording materials. Such recording materials are normally white or colorless until imaged. Color substrates may be used in specialty applications.

Interference pigments are available commercially from companies such as Flex Products, Merck, BASF and Wacker Chemie. Other interference pigments are available under the tradename ALUCOLOR from Eckart-Werke, Germany. Coated aluminum interference pigments are sold by Showa Aluminum Powder K.K., Japan, under the tradename ALOXAL.

Interference pigments typically consist of various layers of metal oxide deposited onto mica. Through interference of the reflected rays of light, an intense color is observed at the angle of reflection. Against a black background, the reflected interference color is observed as the expressed hue. This phenomena can be advantageously adopted to make possible a new class of direct thermally imaging materials, especially based on those traditionally expressing a black or dark coloration of the normally colorless chromogen.

Mica particles used as interference pigments are typically coated with extremely thin layers of either titanium dioxide (Ti0₂) or iron oxide (Fe₂0₃) both of which have high refractive indexes. The color of the reflected light varies, depending on the thickness of the metal oxide layer. By applying increasingly thick coatings of titanium dioxide, a spectrum ranging from silver through yellow, red and blue to green is produced. Colors ranging from bronze through copper to red result from increasing the thickness of iron oxide coatings onto mica particles. When interference pigments based on titanium dioxide are given an additional layer of iron or chrome oxide, or combined with a conventional absorption pigment, the range of colors increases further. By immersing interference pigments in a surrounding vehicle (e.g., oil, acrylic emulsion or polymeric binder) the refractive indexes of all the components can be preselected and specific colors selectively intensified. The layer thicknesses that produce specific colors can be readily discerned.

The thermally responsive record material comprises a support having provided thereon in substantially contiguous relationship an electron donating dye precursor, an acidic developer material, and optionally a sensitizer and binder therefor.

The record material according to the invention has a non-reversible image in that it is substantially non-reversible under the action of heat. The coating of the record material of the invention is basically a dewatered solid at ambient temperature.

The color-forming system of the record material of this invention includes chromogenic material (electron-donating dye precursor) in its substantially colorless or light-colored state and acidic developer material. The color-forming system relies upon melting, softening, or subliming one or more of the components to achieve reactive, color-producing contact with the chromogen.

The record material includes a substrate or support material which is generally in sheet form. For purposes of this invention, sheets can be referred to as support members and are understood to also mean webs, ribbons, tapes, belts, films, cards and the like. Sheets denote articles having two large surface dimensions and a comparatively small thickness dimension. The substrate or support material can be opaque, transparent or translucent and could, itself, be colored or not. The material can be fibrous including, for example, paper or plastic such as filamentous synthetic materials. It can be a plastic such as film including, for example, cellophane and synthetic polymeric sheets cast, extruded, or otherwise formed. The invention resides in the compositions coated on the substrate. The type of substrate is a matter of selection and preference without limitation.

The components of the color-forming system are in substantially contiguous relationship, substantially homogeneously distributed throughout the coated layer material deposited on the substrate. The term substantially contiguous is understood to mean that the color-forming components are positioned in sufficient proximity such that upon melting, softening or subliming one or more of the components, a reactive color forming contact between the components is achieved. As is readily apparent to the person of ordinary skill in this art, these reactive components accordingly can be in the same coated layer or layers, or isolated or positioned in separate but adjacent layers. In other words, one component can be positioned in the first layer, and reactive or sensitizer components positioned in a subsequent layer or layers. All such arrangements are understood herein as being substantially contiguous.

In manufacturing the record material, a coating composition is prepared which includes a fine dispersion of the components of the color-forming system, binder material preferably polymeric binder such as polyvinyl alcohol or acrylic latex, surface active agents and other additives in an aqueous coating medium. The composition can additionally contain inert pigments, such as clay, talc, silicone dioxide, aluminum hydroxide, calcined kaolin clay and calcium carbonate; synthetic pigments, such as urea-formaldehyde resin pigments; natural waxes such as Camauba wax; synthetic waxes; lubricants such as zinc stearate; wetting agents; defoamers, sensitizers and antioxidants and p-benzylbiphenyl. Modifiers or sensitizers can also be included in the heat sensitive layer or composition. Sensitizers for example can include acetoacet-o-toluidine, phenyl-1-hydroxy-2-nophthoate, 1,2-diphenonxyethane, p-benzylbiphenyl, benzyl acetate, benzyloxyphenyl ethers (U.S. Pat. No. 6,566,301; 6,599,097; and 6,429,341). The sensitizer typically does not impact any image on its own but as a relatively low melt point solid acts as a solvent to facilitate reaction between the mark forming components of the color-forming system.

The color-forming system components are substantially insoluble in the dispersion vehicle (preferably water) and are ground to an individual average particle size of between about 1 micron to about 10 microns, preferably about 1-3 microns or less. The polymeric binder material is substantially vehicle soluble or a latex dispersion. Preferred water soluble binders include polyvinyl alcohol, hydroxy ethylcellulose, methylcellulose, methyl-hydroxypropylcellulose, starch, modified starches, gelatin and the like. Eligible latex materials include polyacrylates, styrene-butadiene-rubber latexes, polyvinylacetates, polystyrene, and the like. The polymeric binder is used to protect the coated materials from brushing and handling forces occasioned by storage and use of thermal sheets. Binder should be present in an amount to afford such protection in an amount less than will interfere with achieving reactive contact between color-forming reactive materials.

Coating weights can effectively be about 3 to about 9 grams per square meter (gsm) and preferably about 5 to about 6 gsm. The practical amount of color-forming materials is controlled by economic considerations, functional parameters and desired handling characteristics of the coated sheets.

Eligible electron donating dye precursors are chromogenic materials, such as the phthalide, leucauramine and fluoran compounds, for use in the color-forming system. Various chromogenic materials for use in color-forming systems are well known color-forming compounds or dye precursors. Examples of the compounds include Crystal Violet Lactone (3,3-bis(4-dimethylaminophenyl)-6-dimethylaminophthalide, U.S. Pat. No. RE. 23,024); phenyl-incol-, pyrrol-, and carbazol-substituted phthalides (for example in U.S. Pat. Nos. 3,491,111; 3,491,112; 3,491,116; 3,509,174); nitro-, amino-, amido-, sulfon amido-, aminobenzylidene-, halo-, anilino-substituted fluorans (for example, in U.S. Pat. Nos. 3,624,107; 3,627,787, 3,641,011; 3,642,828; 3,681,390); spiro-dipyrans (U.S. Pat. No. 3,971,808); and pyridine and pyrazine compounds (for example, in U.S. Pat. Nos. 3,775,424 and 3,853,869). Other specifically eligible chromogenic compounds, not limiting the invention to any way, are: 3-diethylamino-6-methyl-7-anilino-fluoran (U.S. Pat. No. 3,681,390); 2-anilino-3-methyl-6-dibutylamino-fluoran (U.S. Pat. No. 4,510,513) also known as 3-dibutylamino-6-methyl-7-anilino-fluoran; 3-dibutylamino-7-(2-chloroanilino)fluoran; 3-(N-ethyl-N-tetrahydrofurfurylamino)-6-methyl-7-3,5,6-tris(dime-thylamino)spiro>9H-fluorene-9,1′, (3′H)-isobenzofuran!-3′-one; 7-(1-ethyl-2-methylindol-3-yl)-7-(4-diethylamino-2-ethoxyphenyl)-5,7-dihydrofuro>3,4-b!pyridin-5-one (U.S. Pat. No. 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindol-3-yl)-7-(4-diethylamino-2-ethoxyphenyl)-5,7-dihydrofuro>3,4-b!pyridin-5-one; 3-diethylamino-7,8-benzofluoran; 3,3-bis(1-ethyl-2-methylindo 1-3-yl)phthalide; 3-diethylamino-7-anilinofluoran; 3-diethylamino-7-benzylaminofluoran; 3-phenyl-7-dibenzylamino-2,2′-spiro-di->2H-1-benzopyran! and mixtures of any of the following.

Examples of eligible acidic developer material include the compounds listed in U.S. Pat. No. 3,539,375 as phenolic reactive material, particularly the monophenols and diphenols. Other eligible acidic developer material which can be used also include, without being considered as limiting, the following compounds:

4,4′-isopropylidinediphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicyanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4,-methylbenzophenone; 4,4′-dihydroxybenzophenone; 2,2-bis(4-hydroxyphenyl)-4-methylpentane; benzyl 4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl)pentanoate; alkyl-4,4-bis(4-hydroxyphenyl)pentanoate; 3,3-bis(4-hydroxyphenyl-pentane; 4,4-bis(4-hydroxyphenyl pentanoate; 3,3-bis(4-hydroxyphenyl)-pentane; 4,4-bis(4-hydroxyphenyl)-heptane; 2,2-bis(4-hydroxy-phenyl)butane; 2,2,-methylene-bis(4-ethyl-6-tertiarybutyl phenol); 4-hydroxy-coumarin; 7-hydroxy-4-methylcoumarin; 2,2,-methylene-bis(4-octylphenol); 4,4,-sulfonyldiphenol; 4,4′-thiobis(6-tertiarybutyl-m-cresol); methyl-p-hydroxybenzoate; n-propyl-p-hydroxybenzoate; benzyl-p-hydroxybenzoate. Preferred among these are the phenolic developer compounds. More preferred among the phenol compounds are 4,4,-isopropylindinediphenol, ethyl-4,4-bis(4-hydroxyphenyl)-pentanoate, n-propyl -4,4-bis(4-hydroxyphenyl)pentanoate, isopropyl-4,4-bis(4-hydroxyphenyl)pentanoate, -methyl-4,4-bis(4-hydroxyphenyl)pentanoate, 2,2-bis(4-hydroxy-phenyl)-4-4-methylpentane, p-hydroxybenzophenone, 2,4-dihydroxybenzophenone, 1,1-bis(4-hydroxyphenyl)cyclohexane, and benzyl-p-hydroxybenzoate. Acid compounds of other kind and types are eligible.

Examples of other eligible acidic developer compounds for use with the invention are phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, attapulgite, hallosyte, and the like. Some of the polymers and minerals do not melt but undergo color reaction on fusion of the chromogen.

The color shifting layer is applied as a separate layer over the heat sensitive layer. The color shifting layer is comprised of the color shifting material such as an interference pigment such as metal oxide coated mica dispersed in a laquer, or latex, or other polymeric binder. The dispersant is preferably a film forming material having an index of refraction of less than the refractive index of the color shifting material.

Coating can be applied by any conventional means such as air knife, blade, rod, flexo, curtain, multi-layer curtain and the like.

The heat sensitive layer can be coated over all or just a portion of the sheet. Typically the heat sensitive layer is coated over the entire sheet. If the color shifting layer is spot printed or coated only onto a portion of the sheet, nonetheless a white sheet is typically obtained. The areas of the sheet however that have the color shifting layer express a color different than the imaged color of the underlying heat sensitive layer, which typically would express a black color with appropriate selection of chromogen such as the common fluorans. The white areas coated with the color shifting layer however express a different color, such as a blue metallic.

Such dual coloration capability, or multiple color possibilities with appropriate use of one or multiple chromogens coated on different areas of the sheet, or different or multiple color shifting materials overcoated over the heat sensitive layers make possible a myriad of different expressed color hues. Such materials can be advantageously used to form thermally imaging substrates expressing two or more color hues. The unique metallic effects would be particularly useful in lottery applications, labels, tags, cards, security applications such as passports, tickets, baggage tags and the like without limitation.

The following examples are given to illustrate some of the features of the present invention and should not be considered as limiting. Unless otherwise indicated, all measurements, parts and proportions herein are in the metric system and on the basis of weight.

### EXAMPLES

| Dispersion A - Effective Pigment Slurry | Parts |
|---|---|
| Interference Pigment (optical color shifting material) | 40.0 |
| Defoaming and dispersing agents | 0.4 |
| Water | 59.6 |
| Coating Formulation 1 Using | Dry Parts |

Formulation 1

| | |
|---|---|
| Dispersion A | 10.0 |
| Binder (acrylic latex) | 90.0 |

Formulation 2

| | |
|---|---|
| Dispersion A | 20.0 |
| Binder (acrylic latex) | 80.0 |

### Example 1A

Coating Formulation 1 Using interference pigment Iriodin® 231 (Merck KGaA, Darmstadt, Germany; EMD Chemicals, Gibbstown, N.J.)

### Example 1B

Coating Formulation 2 Using interference pigment Iriodin® 231

### Example 2A

Coating Formulation 1 Using interference pigment Iriodin® 221

### Example 2B

Coating Formulation 2 Using interference pigment Iriodin® 221

### Example 3A

Coating Formulation 1 Using interference pigment HELICONE® SCARABEUS™

### Example 3B

Coating Formulation 2 Using interference pigment HELICONE® SCARABEUS

### Example 4A

Coating Formulation 1 Using interference pigment HELICONE® JADE

### Example 4B

Coating Formulation 2 Using interference HELICONE® JADE (Iriodin is a trademark of Merck, N.J. Helicone and Helicone Scarabeus is a trademark of Wacker Chemie GmbH, Germany).

Each variation was coated at 1.4, 2.8 and 5.0 g/m² as an overcoat over a conventional normally black imaging heat sensitive thermally imaging coated substrate (for convenience an Appleton OPTIMA® thermal product can be employed).

Optionally, a heat sensitive thermal imaging substrate can be prepared as follows:. Ten grams of 2-anilino-3-methyl-6-dibutylaminoflouran are dispersed for 2 hours by means of a media mill together with 14 grams of a 13% aqueous solution of polyvinyl alcohol. Twenty grams of bis(3-allyl-4-hydroxyphenyl)sulfone are dispersed for 2 hours by means of a media mill together with 24 grams of a 9.5% aqueous solution of polyvinyl alcohol. Further, ten grams of 1,2-diphenoxyethane are dispersed for 2 hours by means of a media mill together with 13 grams of a 11% aqueous solution of polyvinyl alcohol. The above-mentioned three dispersions are mixed together, to which is successively added a binder consisting of a ratio of styrene-butadiene latex and polyvinyl alcohol. The resulting mixture is thoroughly mixed to prepare a heat sensitive coating. The coating is applied to a substrate such as a base paper having a basis weight of 64 g/m² to yield a coating (solid) of 3 g/m² dry.

After coating the heat sensitive thermal imaging coating with the coating of interference pigment, the visual results were observed. The results are summarized in the following chart. The comparative example is a conventional Appleton Optima® thermal paper. Optima is a trademark of Appleton Papers Inc., Appleton, Wis.

Observed Thermally Imaged Color
(Coat Weights (Ctwt) of Interference Pigment)

| Variations | Ctwt1.4 g/m² | Ctwt2.8 g/m² | Ctwt5.0 g/m² |
|---|---|---|---|
| Example 1A | Black | Greenish Metallic | Dark Metallic Green |
| | | black | |
| Example 1B | Black | Greenish Metallic | Bright Metallic |
| | | Black | Green |
| Example 2A | Black | Bluish Metallic | Dark Metallic Blue |
| | | Black | |
| Example 2B | Black | Bluish Metallic | Bright Metallic Blue |
| | | Black | |
| Example 3A | Black | Greenish Metallic | Bright Metallic |
| | | Black | Green |
| Example 3B | Black | Dark Metallic | Bright Metallic |
| | | Green | Green |
| Example 4A | Black | Metallic Black | Bright Metallic Jade |
| Example 4B | Black | Dark Metallic | Bright Metallic Jade |
| | | Jade | |
| Comparative | Black | Black | Black |
| Example 1 (no | | | |
| interference | | | |
| pigment) | | | |

| | | |
|---|---|---|
| Example 5 | | |
| Heat sensitive layer | Chromogen | 2-anilino-3-methyl-6- |
| | | dibutylaminofluoran |
| | developer | bis(3-allyl-4- |
| | | hydroxyphenyl)sulfone |
| | binder | acrylic latex |
| | expressed color of heat | Black or neutral |
| | sensitive layer | |
| Color shifting layer | | Titanium oxide coated mica |
| | binder | Acrylic latex |
| | color observed | Metallic blue |
| Example 6 | | |
| Heat sensitive layer | Chromogen | 2-anilino-3-methyl-6- |
| | | dibutylaminofluoran |
| | developer | Bis-(3-allyl-4- |
| | | hydroxyphenyl)sulfone |
| | binder | Acrylic latex |
| | expressed color or heat | Black |
| | sensitive layer | |
| Color shifting layer | color shifting material | Helicone ® scarabeus, |
| | | liquid crystals Wacker |
| | | Chemie |
| | | GmBH, Germany |
| | binder | Acrylic latex |
| Color observed | | Metallic green |

Example 7-12 illustrate typical colors expressed by conventional colorless chromogens and the color expected to be observed when coupled with a color shifting material according to the invention.

### Examples 7-10

| | | | Color Shifting | Thermal System |
|---|---|---|---|---|
| Example | Chromogen | Color | Material | Color Observed |
| 7 | 2-anilino-3-methyl-6- | Black | TiO₂ coated mica | Metallic blue |
| | dibutylaminofluoran | | Iriodin ® 231* | |
| 8 | 3,3-bis(1-ethyl-2-methyl- | Magenta | Helicone ® Maple | Metallic orange |
| | 1H-indol-3-yl)-1(3H)- | Red | liquid crystal | |
| | Isobenzofuranone | | | |
| 9 | 3,3-bis(1-ethyl-2-methyl- | Magenta | Iriodin ® 201* | Metallic copper |
| | 1H-indol-3-yl)-1(3H)- | Red | | |
| | Isobenzofuranone | | | |
| 10 | 3′-phenyl-7-dimethylamino | Dark blue | Iriodin ® 223* | Metallic purple |
| | spiro-2[2H-1-benzopyran- | | | |
| | 2,2′-(2H)-naphtho-(2,1-b)- | | | |
| | pyran] | | | |

*Iriodin is a trademark of Merck KGaA, Darmstadt, Germany.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

The principles, preferred embodiments, and modes of operation of the present invention have been described in the foregoing specification. The invention which is intended to be protected herein, however, are not to be construed as limited to the particular forms disclosed, since those are to be regarded as illustrative rather than restrictive. Variations and changes can be made by those skilled in the art without departing from the spirit and scope of the invention.

1. A thermally-responsive record material comprising a substrate having provided thereon a heat sensitive color-forming composition comprising:
a chromogenic material and an electron accepting developer material,
at least one layer of an optical color shifting material in a polymeric binder coated over the heat sensitive color-forming composition.

2. The thermally-responsive record material according to claim 1 wherein the optical color shifting material layer is coated only over a portion of the heat sensitive color-forming composition provided on the substrate.

3. The thermally-responsive record material according to claim 2 wherein the chromogenic material when thermally imaged expresses a first color in areas of the record material not coated with the optical color shifting material and the same chromogenic material expresses a second metallic non-neutral color when imaged in areas coated with the color shifting material.

4. The thermally-responsive record material according to claim 1 wherein the optical color shifting material is an interference pigment.

5. The thermally-responsive record material according to claim 1 wherein the optical color shifting material is a metal oxide coated mica.

6. The thermally-responsive record material according to claim 1 wherein the optical color shifting material is a light polarizer.

7. The thermally-responsive record material according to claim 1 wherein the optical color shifting material is a titanium dioxide coated mica.

8. The thermally-responsive record material according to claim 1 wherein the optical color shifting material is a titanium oxide coated mica having an optical thickness of 2,000 angstoms or less.

9. The thermally-responsive record material according to claim 1 wherein the optical color shifting material is a zirconium oxide or titanium oxide coated mica, and the oxide has a refractive index of less than 2.

10. The thermally-responsive record material according to claim 1 wherein the optical color shifting material is a high refraction pigment.

11. The thermally-responsive record material according to claim 1 wherein the optical color shifting material has a refractive index of less than 2.

12. The thermally-responsive record material according to claim 1 wherein the optical color shifting material is a high refraction pigment having a particle size of less than one half micrometer.

13. The thermally-responsive record material according to claim 1 wherein a UV layer is provided between the layer of the high refraction pigment and the heat sensitive layer.

14. The thermally-responsive record material according to claim 1 wherein a protective layer is applied over the layer of optical color shifting material.

15. The thermally-responsive record material according to claim 1 wherein the substrate is paper or plastic.

16. The thermally-responsive record material according to claim 1 wherein the chromogenic material is selected to express a black or neutral color.

17. The thermally-responsive record material according to claim 1 wherein the optical color shifting material is a liquid crystal interference pigment.

18. A method of forming faux metallic images on a thermally responsive substrate, the method comprising:
providing a paper or film substrate having a first and second surface;
applying to a first surface of the substrate a coating of a thermally responsive color-forming composition in one or more layers, the thermally responsive color forming composition comprising a colorless or pale colored chromogenic material and an acidic developer material;
dispersing an optical color shifting material into a binder, and
applying over the coating of the thermally responsive color-forming composition at least one layer of the optical color shifting material dispersed in polymeric binder;
thermally imaging the thermally responsive color forming composition by selective application of heat through the layer of optical color shifting material, such that the chromogenic material reacts with the acidic developer material to form a visible color, the chromogenic material visible color being a first color which is optically color shifted by the optical color shifting material to express a second color different from the first color of the chromogenic material.

19. The method of according to claim 18 wherein the coating of thermally responsive color forming composition is applied to only a portion of first surface of the substrate and the optical color shifting material is applied over the entire first surface of the substrate.

20. The method of according to claim 18 wherein the coating of thermally responsive color forming composition is applied to the entire first surface of the substrate and the optical color shifting material is applied over only a portion of the first surface of the substrate wherein the chromogenic material when thermally imaged expresses a first color in areas of the record material not coated with the optical color shifting material and expresses a second non-neutral metallic color when imaged in areas coated with the color shifting material.

21. The method of according to claim 18 wherein the coating of thermally responsive color forming composition is applied to only a portion of the first surface of the substrate and the optical color shifting material is applied over only a portion of the first surface of the substrate.

22. The method according to claim 18 wherein in addition a UV absorbent is overcoated over the layers of optical color shifting material and thermally responsive color forming composition.

23. The method according to claim 18 wherein in addition a polymeric protecting layer is overcoated over the layers of optical color shifting material and thermally responsive color forming composition.
